(19) United States
(12) Patent Application Publication
(10) Pub. No.: US 2009/0241391 A1
(43) Pub. Date: Oct. 1, 2009

(54) Maximum vehicle height information article and method comprising same

(76) Inventor: Don Franklin Sanford, Walton, NY (US)

Correspondence Address: Don F. Sanford, 66 Townsend Street, Walton, NY, 13856, US

(21) Appl. No.: 12/079,326

(22) Filed: Mar. 26, 2008

(51) Int. Cl. G09F 21/04

(52) U.S. Cl. 40/593; 40/591; 40/594

(57) ABSTRACT

A vehicle height display system has an information displaying sheet, pre-printed indicia disposed on the information displaying sheet and a variable information field immediately adjacent the variable information field indicia. The information displaying sheet is made of a flexible material with a front side and a rear side. The rear side is configured to cause the information displaying sheet to adhere to a windshield of a vehicle when the rear side of the information displaying sheet is brought into contact the windshield. The pre-printed indicia is readable from the front side of the information displaying sheet, specifies non-variable information associated with designating an overall height of a vehicle and includes variable information field indicia configured for having the overall height of the vehicle displayed therewith. The variable information field is immediately adjacent the variable information field indicia and is configured for having the overall height of the vehicle displayed therein.

### FIELD OF THE DISCLOSURE

The disclosures made herein relate generally to articles, systems and/or methods for indicating maximum vehicle height information and, more particularly, to placement of an article (e.g., adhesive sticker such as for example a caution sticker) in the upper, interior, driver side of a windshield of a vehicle to inform an operator of the vehicle of an overall height (i.e., maximum vehicle height or maximum clearance) of the vehicle or attached rack or equipment.

### BACKGROUND

The proliferation of roof racks and the like have increased greatly due to their ability to provide versatility in increasing cargo capacity and equipment that a vehicle normally would not be able to carry. Examples of such roof racks include, but are not limited to, racks configured for carrying sport goods (e.g., bikes, kuyaks, etc), racks configured for carrying ladders, racks configured for carrying construction materials, racks configured for carrying general cargo (i.e., luggage), and the like. Such racks can be mounted on the roof of a vehicle, on a cargo bed of a vehicle or any other suitable mounting structure of a vehicle.

Unfortunately, much costly damage has been caused to vehicles, racks, cargo and/or overhanging structures as a result of being struck by vehicles, cargo and/or racks. Examples of such overhanging structures include but are not limited to, canopies, awnings, bridges, height marking structures and the like. These overhanging structures are often struck in this manner even through they have minimum clearance height clearly posted on them. The fact is that these overhanging structures are often struck simply because the driver is unaware of the overall height of the vehicle. This is especially the case where a vehicle has a rack mounted thereon and cargo or equipment attached to the rack. In many cases, cargo and equipment change occasionally such that an overall height of the vehicle changes. Overall height of a vehicle as defined herein refers to the distance from the ground to the highest point of the vehicle or any item attached to the vehicle (e.g., rack, cargo, equipment, etc). Thus, it can be seen that a vehicle that would otherwise not present clearance considerations can present clearance considerations in view of attached aftermarket equipment (e.g., a roof rack, bed rack or the like), cargo attached to or being carried on the vehicle, equipment attached to or being carried on the vehicle, or the like.

Therefore, displaying overall vehicle height information to an operator of a vehicle in a manner that allows them to readily assess such information in combination with posted signage of overhanging structures and in a manner that does not adversely draw their attention away from the road would be advantageous, desirable and useful.

### SUMMARY OF THE DISCLOSURE

One object of the present invention is to provide an information display device (e.g., a sticker) that states the maximum overhead clearance (i.e., overall height) of a motor vehicle. In one embodiment, the vehicle has a cargo carrying rack installed. In other embodiments, the vehicle does not have a cargo carrying rack installed. In all embodiments, the overall height is the height of the highest point of the vehicle, equipment attached to the vehicle or cargo being carried on the vehicle.

Another object of the present invention is to provide a maximum overhead clearance caution sticker that pertains directly to individual specifications (.g., original equipment manufacturer specifications) of a particular vehicle.

Another object of the present invention is to provide a maximum overhead clearance caution sticker that is disposed on the upper, interior driver's side portion of the windshield to provide a clear line of sight with an approaching maximum clearance sign of an overhang to determine if there is adequate clearance for the vehicle to pass underneath.

Yet another object of the present invention is to provide a maximum overhead clearance sticker set having a main faceplate caution sticker with a plurality of overlay stickers to enable a user to modify the faceplate to identify a specific structure that corresponds to the tallest portion of the vehicle (e.g., roof, rack, cargo, bike, etc).

Still another object of the present invention is to provide a maximum overhead clearance sticker that is intended to prevent or limit the potential for damage to vehicles, vehicle cargo, overhangs and the like.

In one embodiment of the present invention, a vehicle height display system comprises an information displaying sheet, pre-printed indicia disposed on the information displaying sheet and a variable information field immediately adjacent the variable information field indicia. The information displaying sheet is made of a flexible material and has a front side and a rear side. The rear side is configured in a manner causing the information displaying sheet to adhere to a windshield of a vehicle when the rear side of the information displaying sheet is brought into contact the windshield. The pre-printed indicia is readable from the front side of the information displaying sheet, specifies non-variable information associated with designating an overall height of a vehicle and includes variable information field indicia configured for having the overall height of the vehicle displayed therewith. The variable information field is immediately adjacent the variable information field indicia and is configured for having the overall height of the vehicle displayed therein.

In another embodiment of the present invention, a vehicle height sticker system having information thereon for allowing an operator of a vehicle to assess at least one of a maximum overall height of the vehicle and a clearance height of an overhanging structure comprises an information displaying sheet, a bonding agent, a protective backing sheet, pre-printed indicia disposed on the information displaying sheet and a variable information field. The information displaying sheet is made of a flexible transparent material and has a front side and a rear side. The bonding agent is disposed on the rear side of the information displaying sheet. The protective backing sheet is releaseably bonded to the bonding agent in a manner allowing the protective backing to be selectively released from the bonding agent without causing the bonding agent to become detached from the information displaying sheet. The pre-printed indicia is readable from the front side of the information displaying sheet, specifies non-variable information associated with designating an overall height of a vehicle and is configured for having the overall height of the vehicle displayed therewith. The variable information field is configured for having the overall height of the vehicle displayed therein.

In another embodiment of the present invention, a method for displaying an overall height of a vehicle on a windshield of the vehicle comprises providing a flexible information displaying sheet having at least one side thereof configured in a manner causing the information displaying sheet to adhere to a windshield of a vehicle when the rear side of the information displaying sheet is brought into contact the windshield, determining an overall height of the vehicle, denoting the overall height in a variable information field of the flexible information displaying sheet in a manner allowing the overall height to be readable from a front side of the information displaying sheet; and adhering the flexible information displaying sheet to an interior, uppermost, driver-side portion of a windshield of the vehicle by engaging the rear side of the flexible information displaying sheet with the windshield. Providing the flexible information displaying sheet has pre-printed indicia disposed on the information displaying sheet and readable from the front side of the information displaying sheet and has a variable information field immediately adjacent the variable information field indicia. The pre-printed indicia include variable information field indicia configured for having the overall height of the vehicle displayed therewith. The pre-printed indicia specify non-variable information associated with designating an overall height of a vehicle. The variable information field indicia are configured for having the overall height of the vehicle displayed therewith and the variable information field is configured for having the overall height of the vehicle displayed therein.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is an illustrative view depicting a need for an embodiment of the present invention;

FIG. 2 is a front plan view showing a vehicle height display article in accordance with an embodiment of the present invention;

FIG. 3 is an illustrative view of a vehicle height display article in accordance with an embodiment of the present invention installed on a vehicle windshield;

FIG. 4 is a side view of a vehicle height display sticker in accordance with an embodiment of the present invention;

FIG. 5 is an exploded side view of a vehicle height display sticker in accordance with an embodiment of the present invention;

FIG. 6 is an illustrative view of a vehicle height display sticker in accordance with an embodiment of the present invention with a protective backing portion being separated from a flexible indicia carrying portion;

FIG. 7 is a front plan view of a vehicle height display sticker set in accordance with an embodiment of the present invention;

FIG. 8 is a front plan view of a overlay sticker of a vehicle height display sticker set in accordance with an embodiment of the present invention applied to a faceplate of the vehicle height display sticker set;

FIG. 9 is a flow chart showing a process for employing a vehicle height display sticker in accordance with an embodiment of the present invention; and

FIG. 10 is a flow chart showing a process for employing a vehicle height display sticker set in accordance with an embodiment of the present invention.

### DETAILED DESCRIPTION OF THE DRAWING FIGURES

Embodiments of the present invention seek to overcome various shortcomings by providing a removable windshield sticker that is placed on the sunscreen portion of the windshield (e.g., upper, interior driver's side portion) directly ahead of the driver. The sticker has pre-printed caution indicia and a blank field for writing the maximum clearance of a rack, equipment or vehicle structure that defines an overall height of the vehicle. It is disclosed herein that the embodiments of the present invention can be employed to state the maximum clearance of cargo that is carried on the rack of vehicle. For instance, this is particularly useful to contractors that typically carry a certain number of ladders and pump jacks on the roof of their truck. They would measure the height from the top of the cargo to the ground and write that measurement in the appropriate place on the caution sticker. When the driver is approaching an overhang that states its clearance, the sticker is aligned with the driver's line of sight (vision) and he can determine if it is safe to continue.

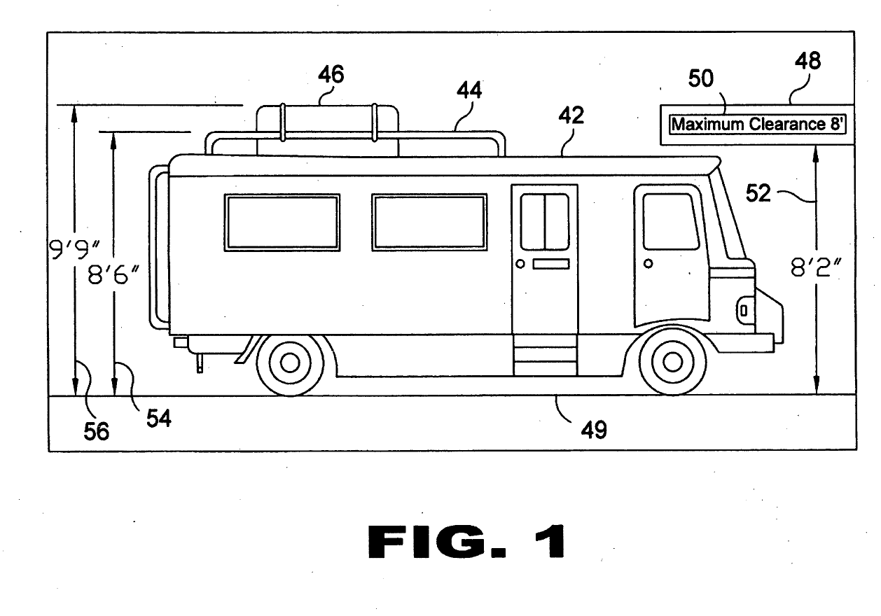

Turning now to discussion of the drawing figures, FIG. 1 is an illustrative view of a need for embodiments of the present invention. Shown in FIG. 1 is a motor vehicle 42 (depicted herein as a RV) with a roof rack 44 laden with cargo 46 approaching an overhang 48 with a maximum clearance sign 50 (depicted on the side of the overhang for illustrative purposes). The maximum clearance sign advises that the maximum clearance is eight (8′) feet. Also shown dimensionally is that the actual overhang height 52 is 8′2″, the roof rack 54 is 8′6″ and the cargo height is 9′9″, thereby indicating that the vehicle 42 cannot pass underneath the overhang 52 without causing damage to the vehicle 42, the roof rack 44 and/or the cargo 46. In this manner, a vehicle height display article (e.g., sticker) in accordance with an embodiment of the present invention seeks to prevent or limit the potential for such damage and costly accidents.

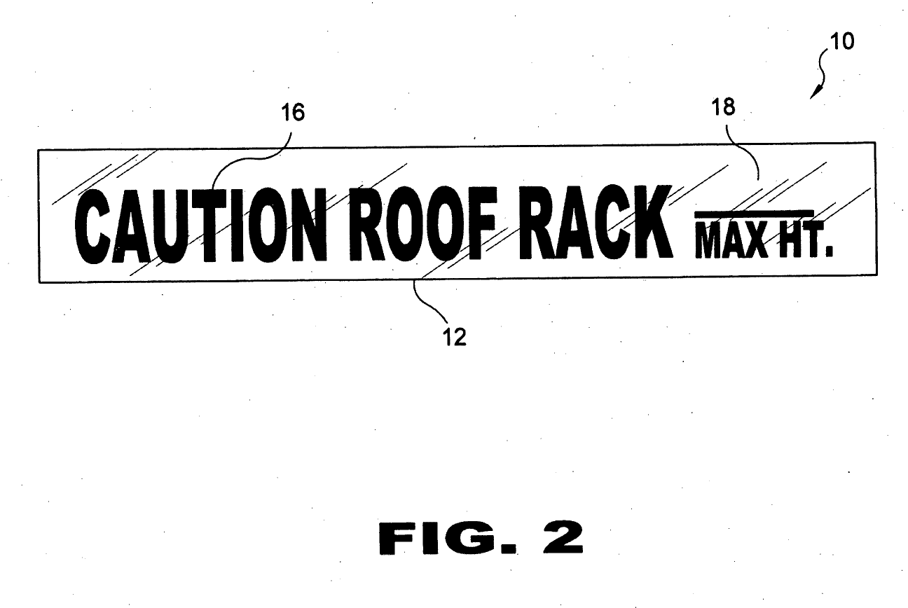

FIG. 2 is a front plan view showing a vehicle height display sticker 10 in accordance with an embodiment of the present invention. The vehicle height display article 10 includes an adhesive-backed caution sticker 12 with pre-printed indicia 16 stating “CAUTION ROOF RACK MAX HT.”. The “MAX HT” portion of the pre-printed indicia 16 is preferably, but not necessarily, printed in smaller font size relative to the other indicia. The smaller font size provides a max height field 18 (i.e., variable information field/empty space) thereabove for writing (i.e., marking) a measured overall height of a vehicle on which the vehicle height display article 10 is to be affixed. Preferably, but not necessarily, the pre-printed indicia 16 are red in color or a color that indicates the importance of such indicia.

The “MAX HT” portion of the pre-printed indicia 16 is variable information field indicia. Preferably, such variable information field indicia include at least one of one words and an abbreviation communicating the context of information provided within the variable information field. Example of indicia that communicating the context of information provided within the variable information field includes at least one of one of words denoting the term “Maximum Height”, an abbreviation denoting the term “Maximum Height”, words denoting the term “Maximum Clearance Height”, an abbreviation denoting the term “Maximum Clearance Height”, words denoting the term “Clearance Height”, and an abbreviation denoting the term “Clearance Height”.

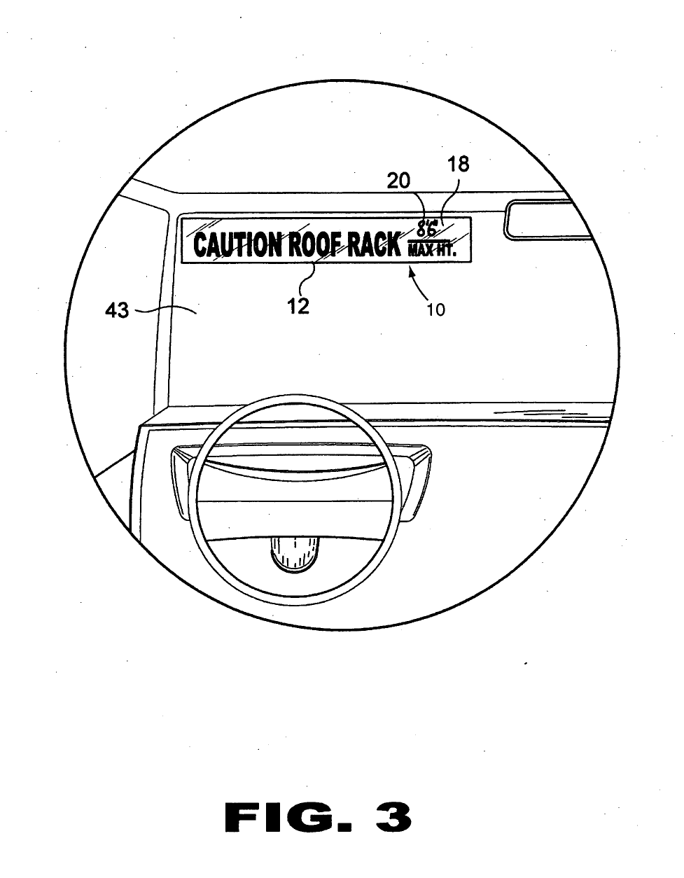

FIG. 3 is an illustrative view of the vehicle height display sticker 10 installed on a windshield 43 of a vehicle 42. The rack height 44 has been measured and the corresponding height indicia 20 (i.e., variable information) have been hand written in the max height field 18. In this manner, the max height field 18 has been configured for having variable information marked therein (i.e., marked within a variable information field). In at least one embodiment of the present invention, the max height field 18 includes a surface configured for having the overall height of the vehicle manually marked thereon with a manually operated marking instrument. A surface coating that absorbs ink and/or that deduces the potential for the smearing of ink are examples of a surface configured for having the overall height of the vehicle manually marked thereon with a manually operated marking instrument.

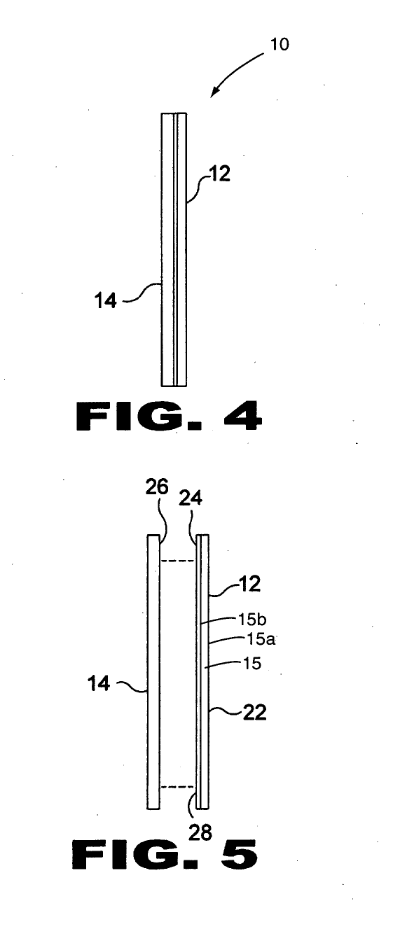

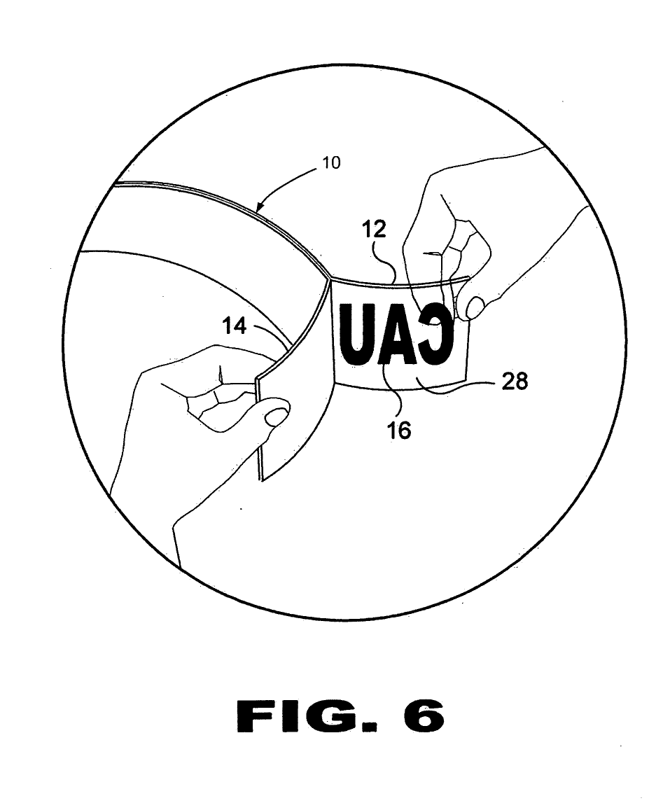

FIG. 4 is a side view of the vehicle height display sticker 10 showing that the vehicle height display sticker 10 includes indicia carrying portion 12 and a protective backing sheet 14. The indicia carrying portion 12 has a laminate construction including a sheet of flexible polymeric film 15 having the pre-printed indicia 16 provided on a front side 15a thereof, a bonding agent 28 (e.g., a pressure sensitive adhesive) disposed on a rear side 1 5b thereof, and a protective backing sheet 14 releaseably bonded over the bonding agent 28. As shown in FIG. 5, the boding agent 28 becomes exposed when the protective backing sheet 14 is removed (i.e., released) from the bonded agent 28. The protective backing sheet 14 is releaseably bonded to the bonding agent 28 in a manner allowing the protective backing sheet 14 to be selectively released from the bonding agent 28 without causing the bonding agent 28 to become detached from the polymeric film 15. It is disclosed herein that a vehicle height display article in accordance with an embodiment of the present invention can be made from a cling-type film that does not reply upon a discrete bonding agent for allowing the vehicle height display article to be affixed to a windshield or other smooth surface of a vehicle.

FIG. 6 is an illustrative view of the vehicle height display sticker 10 showing the protective backing sheet 14 being separated from the indicia carrying portion 12 to expose the boding agent. As shown, the flexible polymeric film 15 and the bonding agent 28 are configured to provide for transparency or translucency such that light passes through the vehicle height display sticker 10 and, preferably, a person can see through portions of the vehicle height display sticker 10 that do not have indicia provided thereon. Thus, pre-printed indicia 16 and transparent properties of the vehicle height display sticker 10 are disclosed.

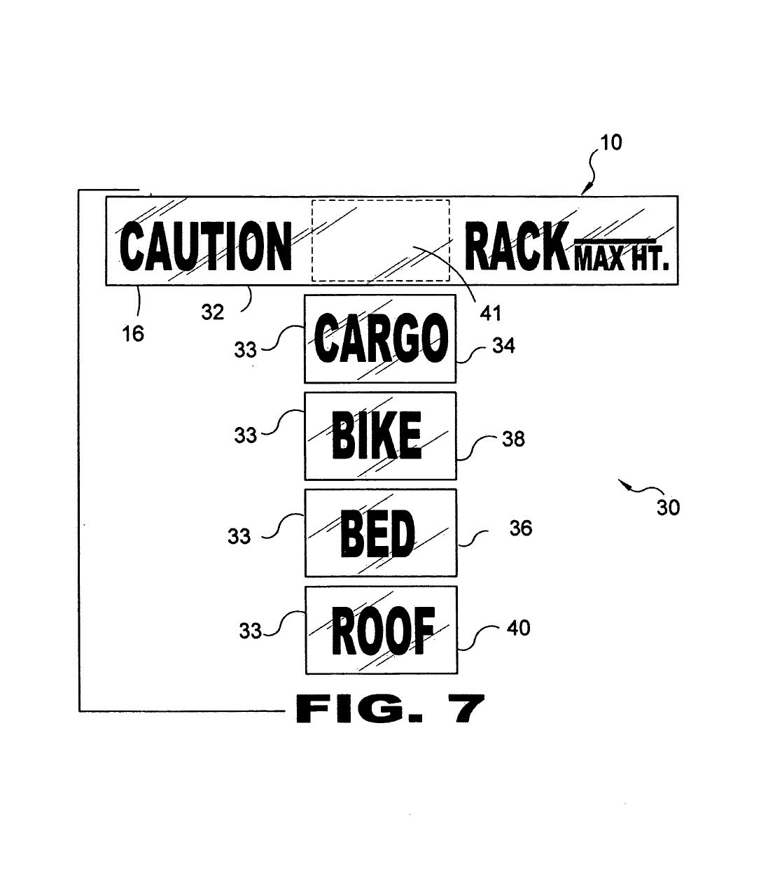

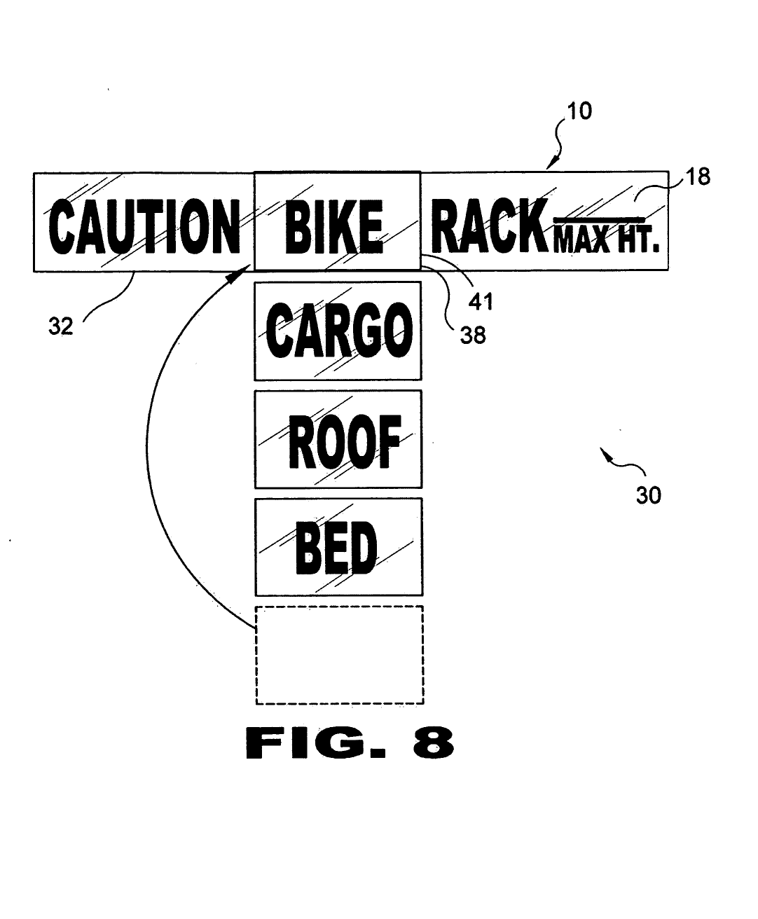

FIGS. 7 and 8 show a vehicle height display sticker set 30 in accordance with an embodiment of the present invention. The sticker set 30 includes a faceplate sticker 32 and a plurality of overlay stickers 33. The pre-printed indicia 16 provided on the faceplate sticker 32 is substantially of the same configuration as the vehicle height display sticker 10 discussed above with the distinction that the word “ROOF” in the pre-printed indicia 16 of the vehicle height display sticker 10 with respect to material configuration, indicia printing, etc. A key difference between the faceplate sticker 32 and the vehicle height display sticker 10 is that fixed structure-specific indicia of the vehicle height display sticker 10 is replaced by a space defining an overlay field 41 into which one of the overlay stickers 33 can be affixed. Each one of the overlay stickers 33 also has a similar construction as the vehicle height display sticker 10 with respect to material configuration, indicia printing, etc. In this manner, the faceplate sticker 32 and a plurality of overlay stickers 33 can be components of a vehicle height display system including a variety of different stickers (i.e., articles).

The overlay stickers 33 each include respective structure-specific pre-printed text disposed thereon that specifies a respective structure (i.e., vehicle structure) defining the maximum overall height of a vehicle on which the faceplate sticker 32 is to be affixed. Embodiments of the present invention are not limited to overlay stickers 33 designative any particular vehicle structure. As shown in FIGS. 7 and 8, one embodiment of the vehicle height display sticker set 30 includes a first overlay sticker 34 denoting “CARGO”, a second overlay sticker 36 denoting “BED”, a third overlay sticker 38 denoting “BIKE”, and a fourth overlay sticker 40 denoting “ROOF”.

FIG. 8 shows the faceplate sticker 32 having a use selected on of the overlay stickers (i.e., the third overlay sticker 38 denoting “BIKE”) affixed within the overlay field 41. The user selected overlay has had its protective backing removed therefrom thereby allowing the indicia carrying portion of the overlay sticker 38 to be adhesively bonded within the overlay field 41 of the faceplate sticker 32. The remaining task prior to installing the faceplate sticker 32 is marking within the max height field 18 the measured overall height of the vehicle to which the faceplate sticker 32 is to be affixed.

It is disclosed herein that a user of a vehicle height display sticker or vehicle height display sticker set in accordance with an embodiment of the present invention can use different criteria for determining the overall vehicle height depending upon the application and/or structure-specific considerations. For example, an empty bike rack on a vehicle rarely poses a clearance hazard. However, a bicycle mounted on the bike rack clearly could be a hazard. Therefore, in this example, the measurement posted in the maximum height field 18 would be from the ground to the highest point of the mounted bike, providing no other vehicle or cargo structure was higher than the bike.

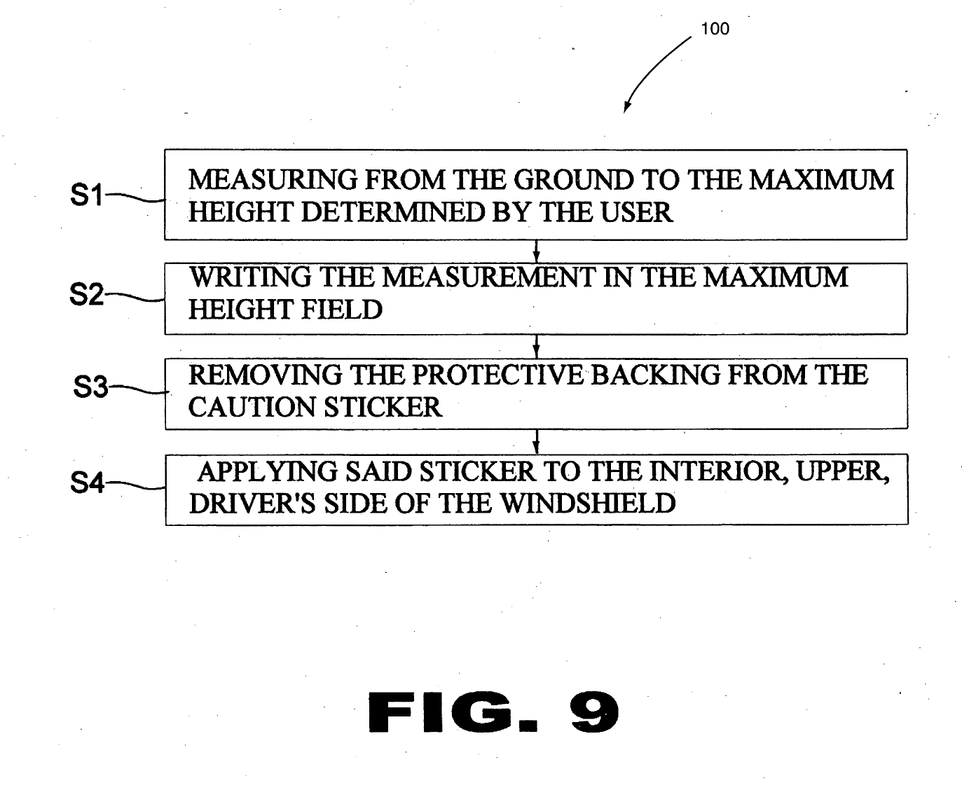

Referring now to FIG. 9, a process 100 for employing a vehicle height display sticker in accordance with an embodiment of the present invention is shown. The process 100 includes a first step S I measuring from the ground to structure defining the overall height of a vehicle to which the vehicle height display sticker is to be affixed. A second step S2 is then performed for writing (i.e., marking) the measured overall height in the maximum height field of the vehicle height display sticker. Thereafter, a third step S3 is performed for removing a protective backing from an indicia carrying portion of the vehicle height display sticker, followed by a fourth step S4 for applying the indicia carrying portion of the vehicle height display sticker to an interior, upper, driver's side of a windshield of the vehicle.

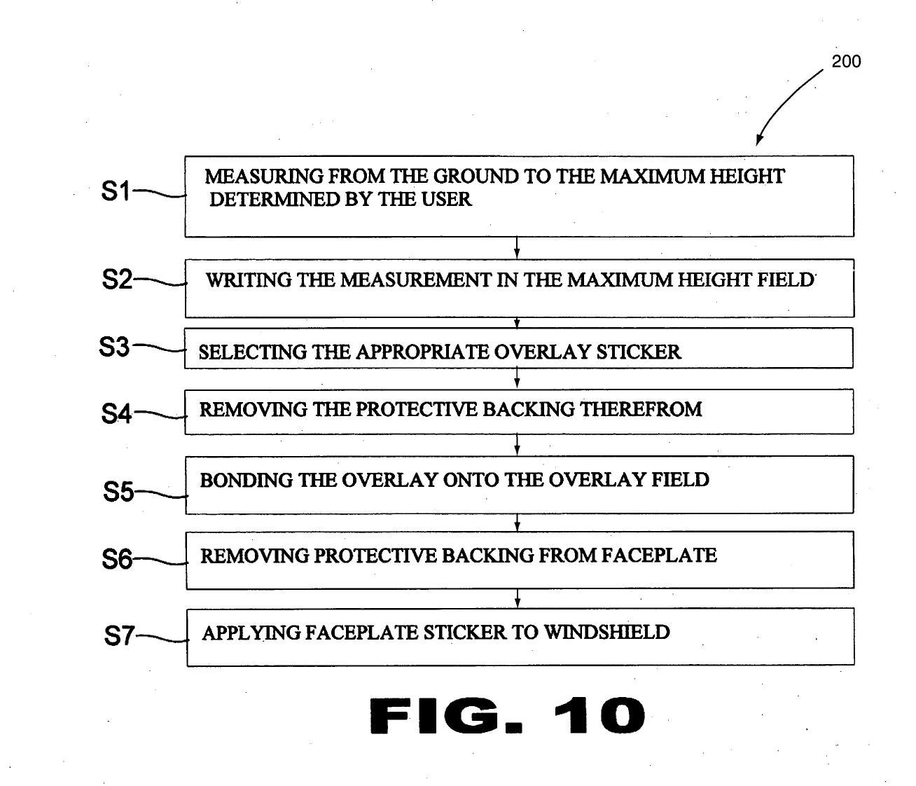

Referring now to FIG. 10, a process 200 for employing a vehicle height display sticker set in accordance with an embodiment of the present invention is shown. The process 200 includes a first step SI measuring from the ground to structure defining the overall height of a vehicle to which the vehicle height display sticker is to be affixed. A second step S2 is then performed for writing (i.e., marking) the measured overall height in the maximum height field of a faceplate sticker of the vehicle height display sticker set. Next, a third step S3 is performed for selecting an overlay sticker that corresponds to a vehicle structure that defines the maximum overall height of the vehicle. A fourth step S4 is then performed for removing a protective backing from an indicia carrying portion of the overlay sticker and a fifth step S5 is then performed for bonding the overlay sticker into a overlay field of the faceplate sticker. Thereafter, a sixth step S6 is performed for removing a protective backing from an indicia carrying portion of the vehicle height display sticker, followed by a seventh step S7 for applying the indicia carrying portion of the vehicle height display sticker to an interior, upper, driver's side of a windshield of the vehicle.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. (canceled)

2. (canceled)

3. (canceled)

4. A vehicle height display system comprising:
an information displaying sheet made of a flexible material and having a front side and a rear side, wherein the rear side is configured in a manner causing the information displaying sheet to adhere to a windshield of a vehicle when the rear side of the information displaying sheet is brought into contact with the windshield;
pre-printed indicia disposed on the information displaying sheet and readable from the front side of the information displaying sheet, wherein:
the information displaying sheet is a faceplate configured for having a structure-specific overlay sheet mounted thereon;
being configured for having the structure-specific overlay sheet mounted thereon includes providing a spaced adjacent to said pre-printed indicia in which the structure-specific overlay sheet is mounted;
pre-printed indicia disposed on the structure-specific overlay sheet is readable from the front side of the information displaying sheet when the structure-specific overlay sheet is mounted on the information displaying sheet;
said pre-printed indicia disposed on the structure-specific overlay sheet and said pre-printed indicia disposed on the information displaying sheet each include text having substantially common font characteristics;
said pre-printed indicia specifies non-variable information associated with designating an overall height of a vehicle; and
said pre-printed indicia includes variable information field indicia configured for having the overall height of the vehicle displayed therewith;
a variable information field immediately adjacent said variable information field indicia, wherein the variable information field is configured for having the overall height of the vehicle displayed therein; and
a plurality of said structure-specific overlay sheets each having respective structure-specific pre-printed text disposed thereon, wherein said structure-specific pre-printed text of each one of said structure-specific overlay sheets specifies a respective vehicle structure that defines the maximum overall height of the vehicle, wherein:
a first one of said structure-specific overlay sheets includes pre-printed text disposed thereon denoting “CARGO” as the respective vehicle structure that defines the maximum overall height of the vehicle;
a second one of said structure-specific overlay sheets includes pre-printed text disposed thereon denoting “BED” as the respective vehicle structure that defines the maximum overall height of the vehicle;
a third one of said structure-specific overlay sheets includes pre-printed text disposed thereon denoting “BIKE” as the respective vehicle structure that defines the maximum overall height of the vehicle; and
a fourth one of said structure-specific overlay sheets includes pre-printed text disposed thereon denoting “ROOF” as the respective vehicle structure that defines the maximum overall height of the vehicle.

5. The vehicle height display system of claim 4 wherein:
said variable information field indicia disposed on the information displaying sheet has a space associated therewith in which the overall height of the vehicle is displayable; and
said variable information field indicia includes at least one of one words and an abbreviation communicating the context of information provided within the variable information field.

6. (canceled)

7. (canceled)

8. (canceled)

9. (canceled)

10. (canceled)

11. (canceled)

12. A vehicle height sticker system having information thereon for allowing an operator of a vehicle to assess at least one of a maximum overall height of the vehicle and a clearance height of an overhanging structure, comprising:
an information displaying sheet made of a flexible transparent material and having a front side and a rear side;
a bonding agent disposed on the rear side of the information displaying sheet;
a protective backing sheet releaseably bonded to the bonding agent in a manner allowing the protective backing sheet to be selectively released from the bonding agent without causing the bonding agent to become detached from the information displaying sheet;
pre-printed indicia disposed on the information displaying sheet and readable from the front side of the information displaying sheet, wherein:
the information displaying sheet is a faceplate configured for having a structure-specific overlay sheet mounted thereon;
being configured for having the structure-specific overlay sheet mounted thereon includes providing a spaced adjacent to said pre-printed indicia in which the structure-specific overlay sheet is mounted;
pre-printed indicia disposed on the structure-specific overlay sheet is readable from the front side of the information displaying sheet when the structure-specific overlay sheet is mounted on the information displaying sheet;
said pre-printed indicia disposed on the structure-specific overlay sheet and said pre-printed indicia disposed on the information displaying sheet each include text having substantially common font characteristics; and
said pre-printed indicia specifies non-variable information associated with designating an overall height of a vehicle and is configured for having the overall height of the vehicle displayed therewith;
a variable information field immediately adjacent a portion of said pre-printed indicia having a variable information field indicia, wherein the variable information field is configured for having the overall height of the vehicle displayed therein; and
a plurality of said structure-specific overlay sheets each having respective structure-specific pre-printed text disposed thereon, wherein said structure-specific pre-printed text of each one of said structure-specific overlay sheets specifies a respective vehicle structure that defines the maximum overall height of the vehicle, wherein:
a first one of said structure-specific overlay sheets includes pre-printed text disposed thereon denoting “CARGO” as the respective vehicle structure that defines the maximum overall height of the vehicle;
a second one of said structure-specific overlay sheets includes pre-printed text disposed thereon denoting “BED” as the respective vehicle structure that defines the maximum overall height of the vehicle;
a third one of said structure-specific overlay sheets includes pre-printed text disposed thereon denoting “BIKE” as the respective vehicle structure that defines the maximum overall height of the vehicle; and
a fourth one of said structure-specific overlay sheets includes pre-printed text disposed thereon denoting “ROOF” as the respective vehicle structure that defines the maximum overall height of the vehicle.

13. The vehicle height sticker system of claim 12 wherein:
said variable information field indicia disposed on the information displaying sheet has a space associated therewith in which the overall height of the vehicle is displayable; and
said variable information field indicia includes at least one of one words and an abbreviation communicating the context of information provided within the variable information field.

14. (canceled)

15. (canceled)

16. (canceled)

17. A method for displaying an overall height of a vehicle on a windshield of the vehicle comprising:
providing a flexible information displaying sheet having at least one side thereof configured in a manner causing the information displaying sheet to adhere to a windshield of a vehicle when the rear side of the information displaying sheet is brought into contact the windshield, having pre-printed indicia disposed on the information displaying sheet and readable from the front side of the information displaying sheet and having a variable information field immediately adjacent said variable information field indicia, wherein said pre-printed indicia includes variable information field indicia configured for having the overall height of the vehicle displayed therewith, wherein said pre-printed indicia specifies non-variable information associated with designating an overall height of a vehicle, wherein said variable information field indicia is configured for having the overall height of the vehicle displayed therewith and wherein the variable information field is configured for having the overall height of the vehicle displayed therein;
determining an overall height of the vehicle;
denoting the overall height in the variable information field in a manner allowing the overall height to be readable from the front side of the information displaying sheet; and
adhering the flexible information displaying sheet to an interior, uppermost, driver-side portion of a windshield of the vehicle by engaging the rear side of the flexible information displaying sheet with the windshield.

18. The method of claim 17, further comprising:
providing a plurality of structure-specific overlay sheets each having respective structure-specific pre-printed indicia disposed thereon, wherein said structure-specific pre-printed indicia of each one of said structure-specific overlay sheets specifies a respective vehicle structure that defines the maximum overall height of the vehicle, wherein the information displaying sheet is a faceplate configured for having one of said structure-specific overlay sheet mounted thereon, wherein being configured for having the structure-specific overlay sheet mounted thereon includes providing a space adjacent to said pre-printed indicia in which the structure-specific overlay sheet is mounted, and wherein pre-printed indicia disposed on the structure-specific overlay sheet is readable from the front side of the information displaying sheet when the structure-specific overlay sheet is mounted on the information displaying sheet;
selecting one of said structure-specific overlay sheets; and
mounting said selected structure-specific overlay sheets to the information displaying sheet within the space.

19. The method of claim 18 wherein:
said variable information field indicia disposed on the information displaying sheet has a space associated therewith in which the overall height of the vehicle is displayable; and
said variable information field indicia includes at least one of one words and an abbreviation communicating the context of information provided within the variable information field.

20. The method of claim 19 wherein denoting the overall height includes manually marking the overall height of the vehicle within the variable information field.
